(19) United States
(12) Patent Application Publication
(10) Pub. No.: US 2007/0121754 A1
(43) Pub. Date: May 31, 2007

(54) Digital rf transceiver with multiple imaging modes

(76) Inventor: David Lowell Mcneely, Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/572,695

(22) PCT Filed: Sep. 25, 2003
(86) PCT No.: PCT/US03/29949

§ 371 Date: Mar. 21, 2006

(51) Int. Cl. H04L 27/00; H04K 1/10

(52) U.S. Cl. 375/295; 375/260

(57) ABSTRACT

The disclosed embodiments relate to a digital radio frequency (RF) circuit that creates a signal in a desired range in a frequency spectrum. The RF circuit comprises circuitry that produces a first sample data modulated signal having a first frequency and a first sample data clock rate. An up-sampler modulator receives the first sample data modulated signal and produces a second sample data modulated signal having a second frequency and a second sample data clock rate. The RF circuit may also comprise circuitry that receives the first sample data modulated signal and the second sample data modulated signal and delivers one of the first sample data modulated signal and the second sample data modulated signal for further processing depending on which sample data modulated signal exhibits desirable characteristics for a given operating environment.

### FIELD OF THE INVENTION

The present invention relates to processing orthogonal frequency division multiplexed (OFDMI) signals.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A wireless LAN (WLAN) is a flexible data communications system implemented as an alternative or extension to a wired LAN within a building or campus. Using electromagnetic waves, WLANs transmit and receive data over the air, minimizing the need for wired connections. Thus, WLANs combine data connectivity with user mobility, and, through simplified configuration, enable movable LANs. Some industries that have benefited from the productivity gains of using portable terminals (e.g., notebook computers) to transmit and receive real-time information are the digital home networking, health-care, retail, manufacturing, and warehousing industries.

Manufacturers of WLANs have a range of transmission technologies to choose from when designing a WLAN. Some exemplary technologies are multicarrier systems, spread spectrum systems, narrowband systems, and infrared systems. Although each system has its own benefits and detriments, one particular type of multicarrier transmission system, orthogonal frequency division multiplexing (OFDM), has proven to be exceptionally useful for WLAN communications.

OFDM is a robust technique for efficiently transmitting data over a channel. The technique uses a plurality of sub-carrier frequencies (sub-carriers) within a channel bandwidth to transmit data. These sub-carriers are arranged for optimal bandwidth efficiency compared to conventional frequency division multiplexing (FDM) which can waste portions of the channel bandwidth in order to separate and isolate the sub-carrier frequency spectra and thereby avoid inter-carrier interference (ICI). By contrast, although the frequency spectra of OFDM sub-carriers overlap significantly within the OFDM channel bandwidth, OFDM nonetheless allows resolution and recovery of the information that has been modulated onto each sub-carrier.

The transmission of data through a channel via OFDM signals also provides several other advantages over more conventional transmission techniques. Some of these advantages are a tolerance to multipath delay spread and frequency selective fading, efficient spectrum usage, simplified sub-channel equalization, and good interference properties.

In spite of these advantages, there are some problems with OFDM data transfer. An OFDM System generates base band symbols via a Fast Fourier Transform (FFT) that consist of many samples. The base band signal so. constructed is complex (a real component and an imaginary component) and has a complex frequency content approximating (though less than), half the sampling frequency. The modulation of the base band sample data signal and subsequent demodulation of a sampled data radio frequency (RF) signal is a relatively complex process.

Known methods of digital modulation include separately up-sampling the real and imaginary components with a sample rate converter (filtering process) from a base band sampling rate, S₀, to a sampling rate, S₁, sufficient to carry the base band signal modulated on the desired carrier. The desired sample data complex carrier may be created at the sampling rate S₁. The real part of the base band signal is multiplied with the real part of the complex carrier (cosine) and added to the product of the imaginary part of the base band signal with the imaginary part of the complex carrier (sine) to create a real sample data RF signal. A compensated digital-to-analog (D/A) converter converts the real sample data RF signal to an analog RF signal.

If a first modulation to a carrier of frequency fo has been performed and a carrier of frequency f₁ is desired, there are two conventional continuations. If the first modulated signal is in complex form (cosine and sine components have not been added), then the signal may be treated as a base band signal as above. A second modulation with a complex carrier of (f₁-f₀) will yield the desired result. If the first modulated signal is in real form, one can first regenerate a complex form (typically involving Hilbert filtering) and then continue as set forth above.

Alternatively, if the first modulated signal is in real form, one can perform a second real modulation ((f₁-f₀) cosine) and filter out undesired images that are created. If this is done, undesirable images may be created. A method and apparatus that reduces the complexity of supporting two modulation modes is desirable.

### SUMMARY OF THE INVENTION

The disclosed embodiments relate to a digital radio frequency (RF) circuit that creates a signal in a desired range in a frequency spectrum. The RF circuit comprises circuitry that produces a first sample data modulated signal having a first frequency and a first sample data clock rate. An up-sampler modulator receives the first sample data modulated signal and produces a second sample data modulated signal having a second frequency and a second sample data clock rate. The RF circuit may also comprise circuitry that receives the first sample data modulated signal and the second sample data modulated signal and delivers one of the first sample data modulated signal and the second sample data modulated signal for further processing depending on which sample data modulated signal exhibits desirable characteristics for a given operating environment.

### BRIEF DESCRIPTION OF THE DRAWINGS

In the drawings:

FIG. 1 is a block diagram of an exemplary OFDM transceiver in which the present invention may be employed;

FIG. 2 is a block diagram of a transceiver circuit according to an embodiment of the present invention; and

FIG. 3 is a block diagram of an up-sampler modulator in accordance with an embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

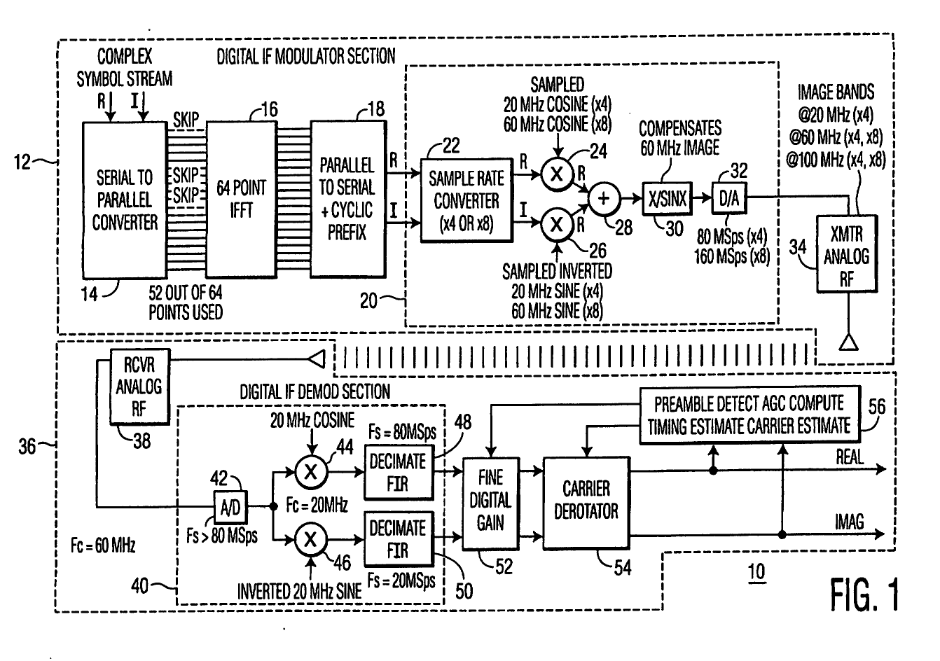

FIG. 1 is a block diagram of an exemplary OFDM transceiver according to an embodiment of the present invention. The transceiver is generally referred to by the reference numeral 10. The transceiver 10 comprises a transmitter portion 12 (shown in dashed lines) and a receiver portion 36 (shown in dashed lines.

The transmitter portion 12 comprises a serial-to-parallel converter 14, which receives a complex symbol stream. The serial-to-parallel converter 14 delivers its output to a 64-point inverse fast Fourier transform (IFFT) circuit 16, which translates the parallelized complex symbol stream from the frequency domain into the time domain. The IFFT circuit 16 delivers its output to a parallel to serial conversion circuit 18, which may also include the capability of generating cyclic prefix information for use in subsequent transmission of a signal. The parallel to serial conversion circuit 18 delivers real and imaginary signal components to a digital intermediate frequency (IF) modulator section 20.

The digital IF modulator section 20 comprises a sample rate converter 22. The sample rate converter upsamples its sample data inputs (first sample rate=20 MSps for illustration) to a higher second sample rate. In principle this second sample rate could be arbitrary selected with appropriate down stream accommodation. Two specific upsampling ratios are referenced: an upsampling by 4 (×4) and an upsampling by 8 (×8). The corresponding post Sample Rate Converter Sample Rates are 80 MSps (20 MSps×4 and, 160 MSps (20 MSps×8). If an upsampling by 4 (×4) was performed, the sampled data of a 60 MHz cosine/sine carrier at an 80 MSps (4×20 MSps) rate is identical to the samples of a 20 MHz cosine/sine at an 80 MSps rate. The real component output of the sample rate converter 22 is delivered to a multiplier 24, which multiplies the real component by a sample data 20 MHz cosine signal (for ×4 sampling) or a sample data 60 MHz cosine signal (for ×8 sampling). The imaginary component output of the sample rate converter 22 is delivered to a multiplier 26, which multiplies the imaginary component by an inverted 20 MHz sine signal (for 4×sampling) or a non-inverted 60 MHz sine signal (for 8×sampling). The sign of the sine carrier compensates for spectral inversion that otherwise occurs due to an odd number of Nyquist folds of a sampled supported spectrum (ex. about 20 MHz @ 80 MSps) into a image about a desired carrier (about 60 MHz which folds with inversion onto 20 MHz from second “panel” of Nyquist folding frequency (80 MSps/2 ) spaced segmentation of frequency.

The outputs of the multipliers 24 and 26 are delivered to a summing circuit 28. The output of the summing circuit 28 is delivered to an x/sinx circuit 30, which compensates the desired post-D/A 60 MHz image. The output of the x/sinx circuit 30 is delivered to a D/A converter 32. The output of the D/A converter 32 is delivered to a transmitter, which transmits the signal.

In an exemplary embodiment of the present invention, the RF signal carrier of the pre-D/A sample data has a frequency equal to the D/A clock rate divided by four (4). The post-D/A analog RF signal carrier is three-fourths (¾) of the D/A clock rate. Images at the clock rate divided by 4 and at five-fourths ( 5/4) of the clock rate (and above) are removed by analog filtering. Choice of another image as the desired RF signal merely requires choice of the appropriate sign of the sin modulator. There are different gains for different images due to the D/A filter response, which must be accommodated via downstream analog processing.

The receiver portion 36 comprises a receiver 38, which receives transmitted RF OFDM signals. The received signal is delivered to a digital IF demodulation section 40 for further processing. The digital IF demodulation section 40 comprises an analog-to-digital (A/D) converter 42, which breaks the received signal into constituent real and imaginary components. The real component is delivered to a multiplier 44, which multiplies it by a 20 MHz cosine signal and delivers the result to a decimate finite impulse response filter (FIR) 48. The imaginary component of the output of the A/D converter 42 is delivered to a multiplier 46, which multiplies it by an inverted 20 MHz sine signal and delivers the result to a decimate FIR filter 50.

The conventional process of digital demodulation is to A/D convert a real signal at a sufficient sample rate to preserve the modulation. In accordance with embodiments of the present invention, a 60 MHz intermediate frequency (IF) signal is sampled at 80 million samples per second (MSps) with a sample and hold circuit with a narrow aperture. This held sample is A/D converted to an 8-bit integer number. The 60 MHz IF pre-A/D signal appears as a post-A/D 20 MHz IF signal due to spectral folding. The real signal is multiplied by a complex exponential matching the frequency of the RF carrier or, in the case of the exemplary embodiment shown in FIG. 1, a folded version of the RF carrier. This will create an over-sampled complex base band signal, which is anti-alias filtered and sub-sampled to the OFDM FFT rate.

The outputs of the FIR filters 48 and 50 are delivered to a fine digital gain circuit 52. The output of the fine digital gain circuit 52 is delivered to a carrier derotator 54, which delivers real and imaginary data components for further processing. The real and imaginary components are additionally provided to a feedback circuit 56, which may provide preamble detection, automatic gain control (AGC) computation, timing estimation and carrier estimation functionality. The output of the feedback circuit 56 is provided to the carrier derotator 54 and the fine digital gain circuit 52.

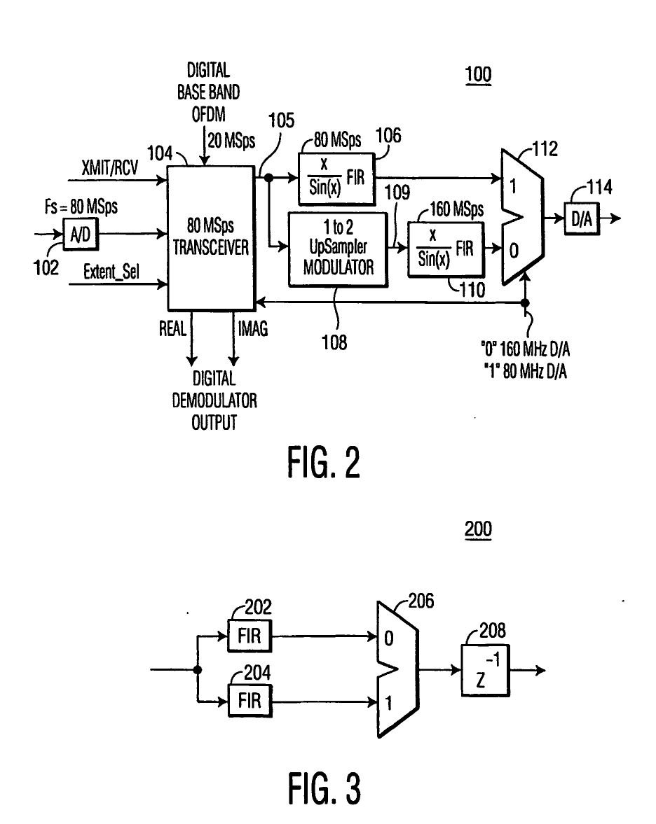

FIG. 2 is a block diagram of a transceiver circuit according to an embodiment of the present invention wherein a multi-imaging mode feature (160 MSps, 60 MHz IF) is added to a transceiver utilizing a single imaging mode (corresponding to the 80 MSps 60 MHz IF mode shown in FIG. 1). The transceiver circuit is generally referred to by the reference numeral 100. The transceiver circuit 100 may perform the functions of the digital IF modulator section 20 (FIG. 1) and the digital IF demodulator section 40 (FIG. 1).

The transceiver circuit 100 supports two different D/A clock rates. The low clock rate is used to generate an IF signal in a frequency band higher than the Nyquist folding frequency. The high clock rate is used to generate an IF signal in the same frequency band but not lower than the now higher Nyquist folding frequency. Susceptibility to non-linear effects of the D/A and self interference as well as electromagnetic interference (“EMI”) effects are different between the two clock modes.

The use of two clock modes in accordance with the present invention may result in a number of advantages. One advantage is that power consumption savings may be obtained by using the lower clock rate circuitry without the need to replicate circuitry. Another advantage is that EMI emissions are different for the two modes of operation. This gives system designers flexibility to choose whichever mode of operation is most compatible with a desired EMI profile. A third advantage is that dynamic range (analog resolution) of the inchannel IF signal for the low clock rate mode is the same as the dynamic range of the inchannel IF signal for the high clock rate mode, even though the signal levels are different.

Those of ordinary skill in the art will appreciate that the proportion of D/A output energy in channel is reduced in the lower clock rate signal and additional analog filtering is required to eliminate an undesired image. Additional analog amplification may be needed for the low clock rate signal if the analog IF signal is noise limited.

Before transmission, the output of the D/A converter 32 (e.g., the IF signal) may travel through additional analog RF circuitry (not shown), which converts the IF signal to an RF signal. The RF signal undergoes impairments of multipath, attenuation, and adjacent channel interference. Meeting a desired specification for a given product relates to this processing chain. Anticipated operating conditions for an IF transmitter may be such that only one operational mode (low clock mode or high clock mode) may be needed for a given application. One could envision using dual mode operation in the same product in a number of scenarios to provide a benefit based on anticipated operating conditions (for example, multi-mode RF post processing, or to allow extra broadcast image if an area of a particular spectrum is not in use).

An A/D converter 102, which may correspond to the A/D converter 42 (FIG. 1), receives an input that may correspond to a received analog OFDM RF signal. The A/D converter 102 delivers its output to an 80 MSps transceiver 104. The 80 MSps transceiver 104 receives a transmit/receive select signal and an extent select signal. A digital base band OFDM signal is also delivered to the 80 MSps transceiver. The 80 MSps transceiver 104 delivers real and imaginary output components as its digital demodulator output.

The 80 MSps transceiver 104 delivers a first sample data modulated signal 105 to an 80 MSps x/sin(x) finite impulse response (FIR) filter 106 and a 1-to-2 up-sampler modulator 108. Although a 1-to-2 up-sampler is illustrated in the embodiment disclosed in FIG. 2, those of ordinary skill in the art will appreciate that up-samplers having other ratios may be used. The 1-to-2 up-sampler modulator 108 delivers a second sample data modulated signal 109 to a 160 MSps x/sin(x) FIR filter 110. The output of the 80 MSps x/sin(x) finite impulse response (FIR) filter 106 and the 160 MSps x/sin(x) FIR filter 110 are delivered as separate inputs to a multiplexer 112. While a multiplexer is illustrated in FIG. 2, those of ordinary skill in the art will appreciate that the function of the multiplexer 112 may be performed by any circuitry that receives multiple inputs and selects one of those inputs as an output.

The multiplexer 112 receives a control input that determines whether transceiver D/A conversion is performed at 80 MSps or 160 MSps. The control signal is also delivered to the 80 MSps transceiver 104. The output of the multiplexer 112 is delivered to a D/A converter 114, which may correspond to the D/A converter 32 (FIG. 1).

In the 80 MSps transceiver 104, the real 80 MSps output (20 MHz carrier) will generate a 60 MHz signal when used with an 80 MSps D/A clock. If the D/A clock is 160 MSps then the 80 MSps transmitter output may be up-sampled to 160 MSps and the OFDM signal on a 20 MHz carrier is converted to a OFDM signal on a 60 MHz carrier.

FIG. 3 is a block diagram of an up-sampler modulator in accordance with an embodiment of the present invention. In FIG. 3, the up-sampler modulator is generally referred to by the reference numeral 200. The up-sampler modulator 200 may correspond to the 1-to-2 up-sampler modulator 108 (FIG. 2). The up-sampler modulator 200 takes the OFDM 20 MHz IF output of a transceiver (such as the 80 MSps transceiver 104 (FIG. 2)) and up-samples and modulates it to an OFDM 60 MHz IF signal at 160 MSps.

The input to the up-sampler modulator 200 is delivered to a FIR filter 202 and a FIR filter 204 in parallel. The outputs of the FIR filters 202 and 204 are delivered as inputs to a 2-to-1 multiplexer 206. The output of the 2-to-1 multiplexer 206 is delivered to a delay line 208. The tap coefficients of the FIR filters 202 and 204 may be expressed, respectively, as follows:
FIR Filter 202:

$$\frac{- 3 + 3 \cdot {z}^{- 1} - 14 \cdot {z}^{- 2} + 38 \cdot {z}^{- 3} + 38 \cdot {z}^{- 4} - 14 \cdot {z}^{- 5} + 3 \cdot {z}^{- 6} - 3 \cdot {z}^{- 7}}{64}$$

where z⁻¹≡one 80 MSps Sample Delay
FIR Filter 204:

$$- \frac{65 \cdot {z}^{- 3}}{64}$$

The Nyquist folding frequency of a 160 MSps is 80 MHz, which corresponds to the real sequence exp(j*pi*n)=cos(pi*n) in the sampled data domain. This modulation can be built in to an up-sampler modulator and will not generate any spurious images.

In the z-plane, the product of the real components of the base band OFDM signal and the complex carrier equate to a real signal at a first carrier frequency. When that signal is ×2 up-sampled, the result equates to the product of the real components of the second real carrier and the first modulated signal re-sampled. That result equates to a digital RF signal at the difference of the two carriers.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A digital radio frequency (RF) circuit that creates a signal in a desired range in a frequency spectrum, comprising:
circuitry that produces a first sample data modulated signal having a first frequency and a first sample data clock rate;
an up-sampler modulator that receives the first sample data modulated signal and produces a second sample data modulated signal having a second frequency and a second sample data clock rate; and
circuitry that receives the first sample data modulated signal and the second sample data modulated signal and delivers one of the first sample data modulated signal and the second sample data modulated signal for further processing depending on which sample data modulated signal exhibits desirable characteristics for a given operating environment.

2. The RF circuit set forth in claim 1, comprising a first filter having first filter characteristics that receives the first sample data modulated signal and a second filter having second filter characteristics that receives the second sample data modulated signal.

3. The RF circuit set forth in claim 2, wherein at least one of the first filter and the second filter comprises a finite impulse response (FIR) filter.

4. The RF circuit set forth in claim 1, wherein the first frequency is less than one half of a frequency of a digital data stream on which the first sample data modulated signal is based.

5. The RF circuit set forth in claim 2, wherein the output of the first filter and the output of the second filter are delivered to the circuitry that receives the first sample data modulated signal and the second sample data modulated signal.

6. The RF circuit set forth in claim 5, wherein the first filter and the second filter each comprise a finite impulse response (FIR) filter.

7. The RF circuit set forth in claim 6, wherein the first filter comprises an 80 MSps FIR filter and the second filter comprises a 160 MSps FIR filter.

8. The RF circuit set forth in claim 1, wherein the RF circuit comprises a portion of an orthogonal frequency division multiplexing (OFDM) transceiver.

9. (canceled)

10. (canceled)

11. (canceled)

12. (canceled)

13. (canceled)

14. (canceled)

15. (canceled)

16. (canceled)

17. A method of processing signals, comprising:
creating a first sample data modulated signal having a first frequency and a first sample data clock rate;
up-sampling the first sample data modulated signal to produce a second sample data modulated signal having a second frequency and a second sample data clock rate; and
selecting between the first sample data modulated signal and the second sample data modulated signal; and
delivering one of the first sample data modulated signal and the second sample data modulated signal for further processing depending on which sample data modulated signal exhibits desirable characteristics for a given operating environment.

18. The method set forth in claim 17, comprising filtering the first sample data modulated signal and the second sample data modulated signal using different filtering characteristics.

19. The method set forth in claim 17, comprising filtering the first sample data modulated signal and the second sample data modulated signal using finite impulse response filters (FIRs) having different filtering characteristics.

20. The method set forth in claim 17, wherein the recited acts are performed in the recited order.
